(19) United States
(12) Patent Application Publication
(10) Pub. No.: US 2017/0063771 A1
(43) Pub. Date: Mar. 2, 2017

(54) ONLINE INFORMATION MANAGEMENT AND DISPLAY METHODS AND SYSTEMS

(71) Applicant: GARY FANG, Inglewood, CA (US)

(72) Inventor: GARY FANG, Inglewood, CA (US)

(21) Appl. No.: 14/835,763

(22) Filed: Aug. 26, 2015

(51) Int. Cl. H04L 12/58; G06F 17/30; H04L 29/08

(52) U.S. Cl. CPC H04L 51/32; H04L 67/02; G06F 17/30023

(57) ABSTRACT

Methods and systems for online management and display of information in a network are disclosed. The method includes displaying an interface including a search field at a display device of a computing device. The method also includes receiving atleast one identifier including a hashtag from the computing device. The method also includes searching for one or more multimedia messages corresponding to the identifier. The multimedia messages may include advertisements, plugins, software widgets, and so forth. Further, the multimedia messages may include hyperlinks to their source websites. The method further includes displaying the one or more multimedia messages at the display device of the computing device in a predefined order based on a membership of a number of second users associated with the one or more multimedia messages.

### FIELD OF THE INVENTION

The present invention generally relates to techniques for online information management and display, such as hashtag management, in a network. Particularly, the present subject matter relates to systems and methods for hash tag based online information management and marketing. The systems and methods may also enable users to search, save, manage, and track multimedia messages over various social media platforms or websites corresponding to hashtags.

### BACKGROUND OF THE INVENTION

With an ever-increasing data and information on the Internet, finding relevant information has become a daunting task. To add to this, the enthusiasm of people to capture every moment of their lives and upload the same on social media networks has made this web of information even more tangled and complex. Constant updating of status, images, locations, activities etc. provides the millions of social media users an opportunity to showcase the social and other aspect of their lives. Amidst this social networking frenzy, a trend that has caught the fancy of users is that of tagging their pictures, data, location and other information to ensure that their data becomes a part of a specific theme based pool of information that can be easily showcased or retrieved at a later time by using the specific tags. One such common tagging mechanism is adding ‘Hashtags’ to any data uploaded on social media.

A hashtag may be a metadata tag or label added to any data posted on social media networks to ensure that users searching for information related to a specific theme or field easily find the data. For example, the hashtag “#YummyItalian” added to a picture of friends at an Italian restaurant showcases visit to an Italian restaurant and the friends' view that the food at the restaurant is great! All that a user needs in order to promptly upload data on social media platforms is a user device such as a smart phone, tablet etc. and a wireless access device such as a wireless router that enables the user device to wirelessly connect to the Internet. Widespread usage of wireless access devices at public and commercial places has become a boon for social networking users to constantly post and tag data on social networking platforms.

Though a great way to sort and access data posted on social media, hashtags and other tagging mechanisms have also resulted in a lot of wrong and redundant categorization of social media data. This is because either user does not know the correct manner of tagging social media data posted by them or lot of non-uniform and random tags are used. For example, for photographs of two different groups of friends dining at the same restaurant, one photograph is tagged “#YummyItalian” while the other is tagged “#AwesomeFood”. Now a user looking for good Italian food online will be able to access the first photograph but not the second due to usage of an overly generic tag. Moreover, in both the instances, the restaurant owner does not benefit in any way as the restaurant is not identified in any of the tags and the owner has to rely on the users' discretion of disclosing the location of dining or the name of the restaurant.

### SUMMARY

In today's world where sorting the pool of information and data available on social media has become essential for enabling meaningful access and utilization of such data, techniques are needed that helps the users to appropriately tag the social media data being uploaded. Also, there is a great need of a method that helps the businesses take advantage of this tagging done by social network users. The systems and methods may also enable users to search, save, manage, and track multimedia messages over various social media platforms or websites corresponding to hashtags.

The present disclosure provides systems and methods for improved techniques for enabling users to manage and view information online based on their hashtags. The present disclosure also provides methods and systems for enabling users to search, save, manage, and track their favorite hash tags in major social media websites using the computing device, which overcomes the above-referenced limitations and others. The present disclosure also provides methods and systems allowing the user to customize unique identifier or tags before publishing the data on the social media websites.

The present disclosure finds particular application in managing and displaying information through various websites, such as social media websites, based on hashtag based searching on the computing devices in a network, and will be described with particular reference thereto. However, it is to be appreciated that the present disclosure is also amenable to other like applications.

The present invention is directed to methods, systems and computer program products for managing information in a network and displaying the informaiton including multimedia messages on a computing device, wherein the information searched or retrieved from the various social media websites based on identifiers such as hashtags.

In one implementation, methods, systems, and computer program products are provided for online management of information in a network. The method displaying, by an interface managing device, an interface at a display device of a computing device. The interface may include atleast one search field for enabling a first user to enter atleast one identifier in the atleast one search field. The identifier may include a hashtag. The method may also include receiving, by a transceiving device, the atleast one identifier from the computing device, wherein the atleast one identifier comprises atleast one hashtag. The method may further include searching, by an information searching device, for one or more multimedia messages corresponding to the atleast one identifier. The method may also include displaying, by the interface managing device, the one or more multimedia messages at the display device of the computing device in a predefined order based on a membership of a plurality of second users associated with the one or more multimedia messages. The placement of multimedia messages in the interface on the display may also depend on paid services taken or subscribed by the user. For example, if the user has paid a priority fee than whenever any user searches for a hashtag associated with multimedia message associated with this tag then the multimedia message is displayed first or at initial place in the predefined order. The order of multimedia messages may be defined or determined by the interface managing device based on the fees paid by the users associated with the multimedia messages.

In one implementation, a computer program product including program instructions tangibly stored on a computer-readable medium and operable to cause a computer system to perform a method is provided. The computer program product stores the instruction for displaying an interface at a display device of a computing device. The interface may include atleast one search field for enabling a first user to enter atleast one identifier in the atleast one search field. The CPP also includes instructions for receiving the atleast one identifier from the computing device. The atleast one identifier may include atleast one hashtag. The CPP also includes instructions for searching for one or more multimedia messages corresponding to the atleast one identifier. The CPP also includes instructions for displaying the one or more multimedia messages at the display device of the computing device in a predefined order based on a membership of a number of second users associated with the one or more multimedia messages. The CPP also includes instructions for displaying the one or more multimedia messages at the display device of the computing device in a predefined order based on a membership of a number of second users associated with the one or more multimedia messages.

In other implementations, the computing device used can be any device which can perform calculations and can be used for generating and/or uploading user generating data for posting on social media by connecting to a network. The computing device without any limitation includes devices like phones, tablet computers, computers, mobile devices, smart phones, and laptops.

An embodiment of the present disclosure provides an information managing system for online management of information in a network. The system may include an interface managing device configured to display an interface including atleast one search field at a display device of a computing device, wherein a first user enters atleast one identifier in the atleast one search field. The system may also include a transceiving device configured to receive atleast one identifier from the computing device. The atleast one identifier may include atleast one hashtag. The system may also include an information searching device configured to search for one or more multimedia messages corresponding to the atleast one identifier. The system may further include a storage device configured to store the one or more multimedia messages and a number of identifiers including hashtags. The interface managing device may further be configured to display the one or more multimedia messages at the display device of the computing device in a predefined order based on a membership of a number of second users associated with the one or more multimedia messages.

Another embodiment of the present disclosure provides a method for enabling a plurality of users to manage a plurality of hashtags in a network. The method may include registering, by a registration device, a user based on one or more registration information provided by the user at the computing device. The method may also include displaying, by an interface managing device, a hashtag managing interface including atleast one search field at a display device of the computing device. The method may further include receiving, by a transceiving device, atleast one hashtag from the computing device. The atleast one hashtag may be entered by the user at the atleast one search field of the displayed interface at the computing device. The method may furthermore include searching, by an information searching device, for one or more multimedia messages corresponding to the received atleast one hashtag in a storage device. The storage device stores the plurality of hashtags, the one or more multimedia messages, and membership information of the plurality of users. The method may also include displaying, by the interface managing device, the one or more multimedia messages at the display device of the computing device.

Yet another embodiment of the present disclosure provides a system for enabling a plurality of users to manage a plurality of hashtags in a network. The system may include a registration device configured to register a user based on one or more registration information provided by the user at the computing device. The system may also include a storage device configured to store a plurality of hashtags, membership information of the plurality of users, one or more multimedia messages, and code for linking the one or more multimedia messages. The system may further include an interface managing device configured to display a hashtag managing interface including atleast one search field at a display device of the computing device. The system may also include a transceiving device configured to receive atleast one hashtag from the computing device. The atleast one hashtag may be entered by the user in the atleast one search field at the computing device. The system may also include an information searching device configured to search for one or more multimedia messages corresponding to the received atleast one hashtag in the storage device. The interface managing device is further configured to display the one or more multimedia messages at the display device of the computing device.

In an implementation, placement of multimedia messages in the interface on the display device may also depend on paid services taken or subscribed by the user. For example, if the user has paid a priority fee than whenever any user searches for a hashtag associated with multimedia message associated with this tag then the multimedia message is displayed first or at initial place in the predefined order. The order of multimedia messages may be defined or determined by the interface managing device based on the fees paid by the users associated with the multimedia messages.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic diagram illustrating an exemplary environment, where various embodiments of the present disclosure may function;

FIG. 1B is another schematic diagram illustrating another exemplary environment, where various embodiments of the present disclosure may function.

FIG. 2 is a block diagram illustrating various system elements of an exemplary information managing system/device, in accordance with an embodiment of the present disclosure;

FIG. 3 is a flowchart illustrating an exemplary method for displaying information based on a hashtag, in accordance with an embodiment of the present disclosure;

FIG. 4 is a flowchart illustrating an exemplary method for registering a user and managing information including multimedia messages associated with the user, in accordance with an embodiment of the present disclosure;

FIG. 5 is a flowchart illustrating an exemplary method for registering a user and displaying information to the user, in accordance with an embodiment of the present disclosure;

FIG. 6 is a flowchart illustrating an exemplary method for removing atleast one multimedia message from an interface, in accordance with an embodiment of the present disclosure;

FIG. 7 is a flowchart illustrating an exemplary method for adding atleast one new multimedia message at an interface, in accordance with an embodiment of the present disclosure; and

FIG. 8A-8D are screenshots of interfaces for managing and displaying information on a computing device, in accordance with different embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as systems or devices. A device or a system may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, atleast partially, as electronic signals on a system or network.

Reference throughout this specification to “a select embodiment,” “one embodiment,” or “an embodiment” means that a particular feature, structure, or characteristic described in connection with the embodiment is included in atleast one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

### NON-LIMITING DEFINITIONS

In various embodiments of the present disclosure, definitions of one or more terms that will be used in the document are provided below.

As used herein, a “computing device” as used herein includes a single device capable of communicating, and exchanging one or messages with other devices present in a network. The computing device is also configured to connect to the network such as the Internet.

As used herein, a “Graphical User Interface” (GUI) can include an interface on a display device of the computing device enabling a user to interact with the device or computing device.

As used herein, a “social media website” refers websites that may allow people to create, share or exchange information, ideas, and pictures/videos in a virtual community or virtual social network.

Further, a “computing device” can include a single device or multiple devices, which may be configured to automatically tag data or data of various images and the data/data posted on various social media websites, and combination of any of these.

As used herein, an “information managing device” refers to a device including a software, hardware or combination of these, that is configured to manage information in a network based on hashtags.

Further, as used herein, an “information searching device” refers to a device including hardware, software, firmware, or combination of these that can be configured to search for multimedia messages corresponding to an identifier or hashtag.

Further, as used herein, a “storage device” refers to a device including hardware, software, firmware, or combination of these that can be configured to store the one or more multimedia messages and a plurality of hashtags.

Further, as used herein, an “interface managing device” refers to a device including hardware, software, firmware, or combination of these. Further, the interface managing device can manage display of an interface at a display device of a computing device in a network.

Further, as used herein, a “transceiving device” is a device configured to transmit or receive data, files, multimedia messages, and images to and from computing device in the network. The transceiving device can include hardware, software, firmware, and combination of these.

As used herein, a “multimedia message” refers to a message including text, image, video, audio, and combination of these.

The device or system for online management of information in a network may be a software, hardware, firmware, or combination of these. The device or the system is further intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

### Exemplary Embodiments

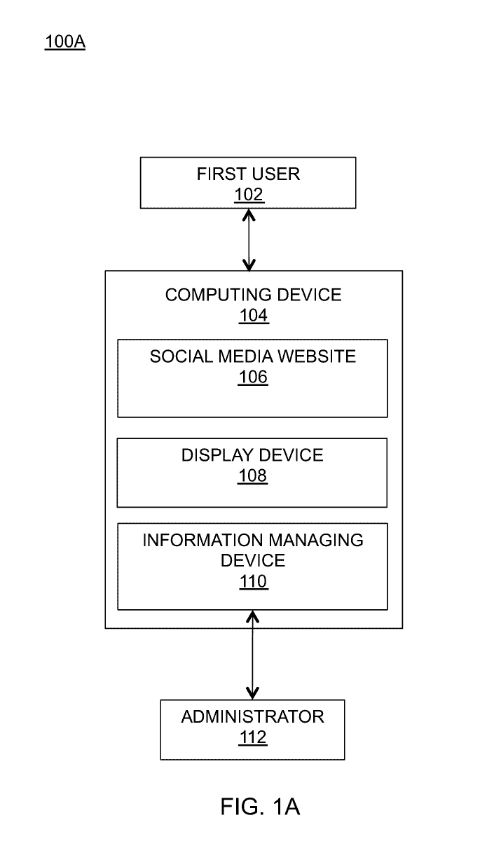

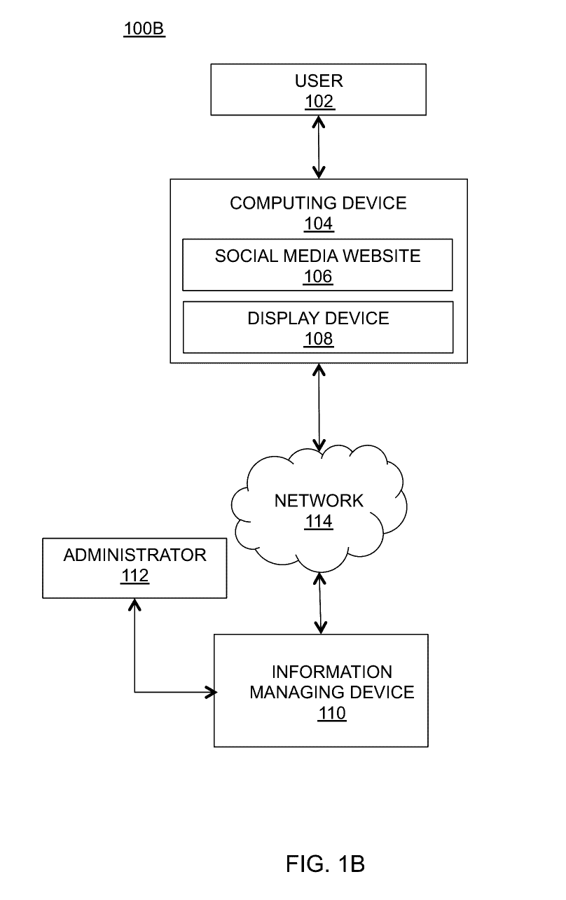

FIG. 1A is a schematic diagram illustrating an exemplary environment 100A, where various embodiments of the present disclosure may function. As shown, the environment 100A may include a computing device 104 associated with a user 102 (or first user 102). The computing device 104 may be any computation device capable of communicating with other devices connected to a network (such as a network 114 as shown in FIG. 1B). The network may be a wired network, a wireless network or combination of these. The computing device 104 may include an associated display device 108. The user 102 may access a browsing application such as but not limited to, Google Chrome, Internet Explorer, Mozilla Firefox, and so forth. Further, the user 102 may open a social media website on the computing device through the browsing application. Examples of the social media website may include, but are not limited to, Instagram™, Facebook™, Twitter™, LinkedIn™, and so forth. Examples of the computing device 104 may include, such as, but are not limited to, a mobile phone, a desktop computer, a laptop computer, a smart phone, a personal digital assistant (PDA), a tablet computer, a smart television, a television, and so forth.

The computing device 104 may also include an information managing device 110 configured to manage and display information to the user 102 based on identifier or hashtag entered by the user 102. The information managing device 110 may be configured to receive one or more inputs from the user 102. The inputs may be keywords, identifiers, hashtags, personal information of the user, and so forth. The information managing device 110 may be configured to display an interface at the display device 108 of the computing device 104. The first user 102 may enter atleast one identifier in the atleast one search field of the interface. The information managing device 110 may be configured to receive the atleast one identifier, such as a hashtag, from the user 102 and search for one or more multimedia messages corresponding to the identifier. In some embodiments, the user 102 may enter more than one identifier. The information managing device 110 may also be configured to store the multimedia messages and a number of identifiers including hashtags. In some embodiments, the multimedia messages are pre-stored multimedia messages stored at the information managing device 110. In alternative embodiments, the multimedia messages are searched or retrieved from various social media websites. In such embodiments, the multimedia messages may include postings including images, text, audio, video, and so forth. Further, the information managing device 110 may also be configured to display the multimedia messages at the display device 108 of the computing device 104 in a predefined order based on a membership of a number second users associated with the one or more multimedia messages. In some embodiments, the order of the multimedia messages may be determined based on payment received from the second users for displaying their associated messages.

In an implementation, placement of multimedia messages in the interface on the display device may also depend on paid services taken or subscribed by the user 102. For example, if the user 102 has paid a priority fee for displaying an associated multimedia message first than whenever any user searches for a hashtag associated with multimedia message associated with this hashtag then the multimedia message is displayed at a first or at initial position in the predefined order on the interface. The order of multimedia messages may be defined or determined by the information managing device 110 based on the fees paid by the users associated with the multimedia messages. For example, the user 102 may avail paid services of the information managing device 110 for displaying their associated multimedia message or advertisement first in the predefined order. Also, the user 102 may choose to display their multimedia message at first position in the predefined order whenever a particular hashtag is searched. The user can provide a list of hashtags on which the priority services need to be availed or his/her multimedia messages should appear first in the predefined order on the interface. In some embodiments, the user may avail paid services for displaying their associated multimedia message at first position or initial positions in the predefined order whenever a location based identifier or hashtag is searched. Further, the user 102 may choose to get their multimedia messages displayed at first positions in the predefined order always whenever a hashtag associated with their multimedia message is searched.

The multimedia messages are associated with the second users such that either the second users have uploaded the multimedia message on the network such as Internet™ or have created the multimedia messages. In an implementation, placement of multimedia messages in the predefined order on the interface on the display device 108 may also depend on paid services taken or subscribed by the user 102 or the second users. For example, if the user (user 102 or second users) has paid a priority fee while uploading a multimedia message or while registering with the information managing device 110, then whenever any user searches for a hashtag associated with multimedia message associated with this hashtag then the multimedia message is displayed first or at initial place in the predefined order. The order of multimedia messages may be defined or determined by the information managing device 110 based on the fees paid by the users associated with the multimedia messages.

Further, each of the multimedia messages may include a hyperlink for allowing the first user 102 to browse to a source website associated with each of the one or more multimedia messages. The source website may be a social media website 106 from where the multimedia message is retrieved so when the first user 102 clicks on one of the multimedia messages, then the browsing application may direct the first user 102 to the source website from where the multimedia message is picked or retrieved by the information managing device 110. In some embodiments, atleast five multimedia messages are displayed at the display device 108 in form of a ring or webring. The ring or webring may be a collection of websites or multimedia messages that are inked together in a circular structure, and may be arranged around a same theme. The information managing device 110 may allow the first user 102 to delete or add a multimedia message from or to the interface by paying a nominal fee.

The information managing device 110 may also be configured to register the first user or the user 102 and the second users by receiving information from the user 102 or second users. The registration information may include a name, a login identifier, a password, an email address or ID, users' time zone, an age of the users, address, payment details, and so forth. The registered user may choose a membership for example, but not limited to, a primary membership, a secondary membership, and so forth. The users may access one or more features of the information managing device or system 110 based on the membership they chose. The users may be allowed to upgrade or downgrade their membership at later stage. Further, in some embodiments, the users may be allowed to access the interface post registration only and when they tare through proper payment of registration fees etc. In some embodiments, the user 102 may enter registration information at a registration interface including atleast one box for entering a code such as a Facebook page plugin ID, multiple boxes for entering hashtags or identifiers, and one box to show Widget Power (WP).

In some embodiments, the information managing device or system 110 may be present on a remote device located in the network 114. FIG. 1B is another schematic diagram illustrating another exemplary environment 100B, where various embodiments of the present disclosure may function. As shown, the information managing device 110 is a separate device and may be located remotely from the computing device 104. The user 102 may access the information managing device 110 via any suitable browsing application when connected to the network 114. The user 102 may enter the information like registration information, the identifier, and the hashtag at the computing device 104. The computing device 104 may be configured to communicate with the information managing device 110 by sending and receiving messages or information over the network 114.

The information managing device 110 may be configured to add a new multimedia message to the interface when a message addition fee is received from the first user 102 (or other user). The new multimedia message may be added based on an addition approval from an administrator 112 of the information managing device 110. The information managing device 110 may also be configured to remove a multimedia messages from the interface when a message removal fee and/or request is received from the first user 102 (or any other user). The multimedia message may be removed based on a message removal approval from the administrator 112.

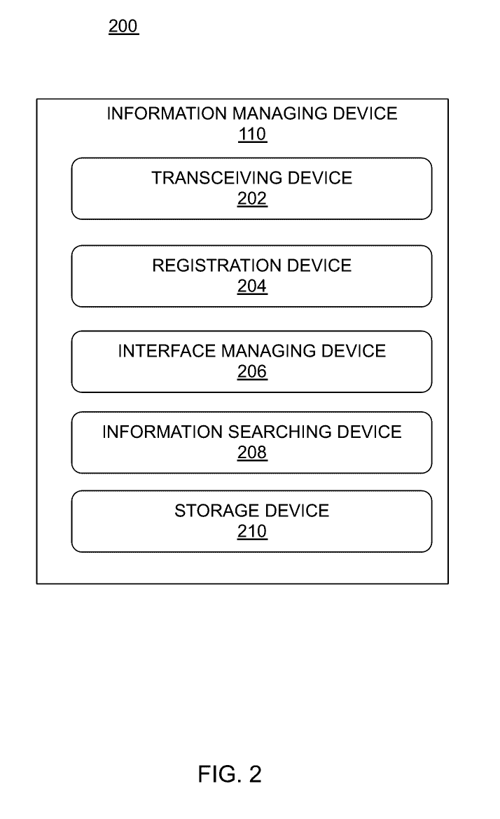

FIG. 2 is a block diagram illustrating various system elements of an exemplary information managing system/device 110 of FIGS. 1A-1B, in accordance with an embodiment of the present disclosure. As shown, the information managing system/device 110 may primarily include a transceiving device 202, a registration device 204, an interface managing device 206, an information searching device 208, and a storage device 210. The information managing device 110 may be located within the computing device 104 as shown in FIG. 1A or may be located remotely in the network 114 as shown in FIG. 1B.

The interface managing device 206 may be configured to display an interface such as a hashtag managing interface, at the display device 108 of the computing device 104. The interface may be a graphical user interface including atleast one search field as discussed with reference to FIGS. 1A-1B. The user 102 can enter one or more inputs or information at the computing device 104. In some embodiments, the user 102 may enter an identifier, such as atleast one hashtag, in the search field. The transceiving device 202 may be configured to receive the inputs or information from the computing device 104. In some embodiments, the atleast one hashtag is received from the computing device 104. The user 102 may enter more than one hashtag in the search field.

The registration device 204 may be configured to register the user 102 or a number of second users with the information managing device 110 based on registration information entered by the user 102 and the second users at the computing device 104. The storage device 210 may be configured to store users' information, hashtags, multimedia messages, registration information, and so forth. The registration information may include name, age, email ID, time zone, password, and so forth. Further, the user 102 may choose from a primary membership or a secondary membership. A user having a primary membership may have privilege to choose to place the multimedia messages ring as header or as footer. In some embodiments, the dashboard or the tabs on the interface may be visible to the user 102 but may not be active. The user 102 may be able to access the dashboard post registration and paying the registration fee.

The information searching device 208 may be configured to search for one or more multimedia messages corresponding to the atleast one identifier or hashtag. In some embodiments, the information searching device 208 may be configured to search for the multimedia messages in the storage device 210. In alternative embodiments, the information searching device 208 may be configured to search for the multimedia messages in a number of social media websites in the network 114.

The interface managing device 206 may be configured to display the one or more multimedia messages at the display device 108 of the computing device 104 in a predefined order based on a membership of the second users associated with the one or more multimedia messages. Each of the multimedia messages may include a hyperlink for allowing the first user 102 to browse to a source website associated with each of the multimedia messages. In some embodiments, atleast five multimedia messages are displayed at the display device 108 in form of a ring or webring. The ring or webring may be a collection of websites or multimedia messages that are inked together in a circular structure, and may be arranged around a same theme.

The interface managing device 206 may be configured to add a new multimedia message to the interface when a message addition fee is received from the first user 102 (or other user). The new multimedia message may be added based on an addition approval from the administrator 112. The interface managing device 206 may also be configured to remove a multimedia messages from the interface when a message removal fee and/or request is received from the first user 102 (or any other user). The multimedia message may be removed based on a message removal approval from the administrator 112.

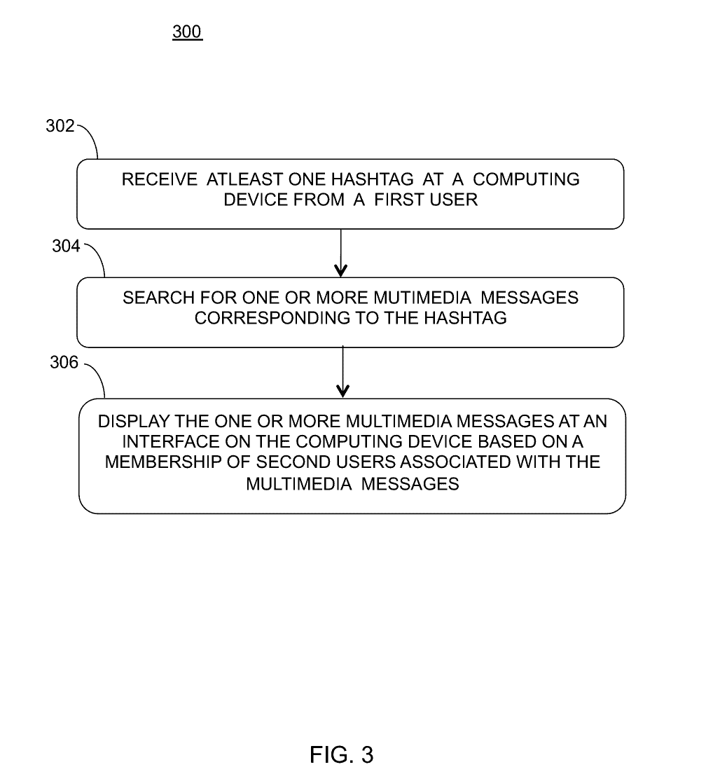

FIG. 3 is a flowchart illustrating an exemplary method 300 for displaying information based on a hashtag, in accordance with an embodiment of the present disclosure. As discussed with reference to FIGS. 1A-1B, the user 102 (or first user 102) may enter atleast identifier at the computing device 104. The identifier may include a hashtag. The hashtag may be a word or phrase preceded by a hash sign (#) that is used social media websites, such as Facebook™, to identify messages or postings on a specific topic or theme. The computing device 104 may include the display device 108. The display device 108 may be configured to display one or more interfaces to the user 102. The user 102 may interact with the computing device 104 via the interfaces. The information managing device 110 may be configured to be part of the computing device 104 or may be located remotely from the computing device 104 in the network 114.

At step 302, atleast one hashtag (or an identifier) is received at the computing device 104. The hashtag may be entered by the user 102 at the computing device 104 by using any suitable input device such as a keypad of the computing device 104 such as, a smart phone. The hashtag may be preceded by a symbol such as a “#”. In some embodiments, the transceiving device 202 may be configured to receive the hashtag from the computing device 104.

At step 304, one or more multimedia messages are searched corresponding to the hashtag. In some embodiments, the multimedia messages are searched in the storage device 210. In alternative embodiments, the multimedia messages are searched in multiple social media websites. Further, the information searching device 208 may search for the multimedia messages in the storage device 210 or in the social media websites (such as social media website 106) over the network 114.

Thereafter, at step 306, one or more multimedia messages may be displayed at an interface on the computing device 104 based on a membership of other users or second users to whom the multimedia messages are associated. In some embodiments, atleast five multimedia messages are displayed at the display device 108 in form of a ring or webring. The ring or webring may be a collection of websites or multimedia messages that are inked together in a circular structure, and may be arranged around a same theme. The multimedia messages may be displayed or arranged in a predefined order on the interface. For example, if one of the second users is a primary member then a multimedia message associated with the second user is displayed first in the predefined order of the displayed multimedia messages on the interface. In some embodiments, atleast five multimedia messages are displayed at the display device 108 in form of a ring or webring. The ring or webring may be a collection of websites or multimedia messages that are inked together in a circular structure, and may be arranged around a same theme.

In some implementations, placement of multimedia messages on the interface on the display device 108 may depend on paid services taken or subscribed by the user 102. For example, if the user 102 has paid a priority fee for displaying his/her associated multimedia message at a first position then whenever any user searches for a hashtag associated with the multimedia message then the multimedia message is displayed at the first or at initial position in the predefined order on the interface. The order of multimedia messages may be defined or determined by the interface managing device 206 based on the fees paid by the users associated with the multimedia messages. For example, the user 102 may avail paid services of the interface managing device 206 for displaying their associated multimedia message or advertisement first in the predefined order for a particular time period only. Also, the user 102 may choose to display their multimedia message at first position in the predefined order whenever a particular hashtag is searched. The user can provide a list of hashtags on which the priority services need to be availed or his/her multimedia messages should appear first in the predefined order on the interface. In some embodiments, the user 102 may avail paid services for displaying their associated multimedia message at first position or initial positions in the predefined order whenever a location based identifier or hashtag is searched. Further, the user 102 may choose to get their multimedia messages displayed at first position in the predefined order always whenever a hashtag associated with their multimedia message is searched.

A user, such as the user 102, having a primary membership may have privilege to choose to place the multimedia messages ring as header or as footer. In some embodiments, the dashboard or the tabs on the interface may be visible to the user 102 but may not be active. The user 102 may be able to access the dashboard post registration and paying the registration fee. The multimedia messages may be postings from the social media websites in the network 114. The multimedia messages may include hyperlinks that may allow the user 102 to browse to a source website of the multimedia message that is clicked or selected. In some embodiments, the interface managing device 206 may display and switch various interfaces at the display device 108 of the computing device 104 based on one or more inputs or clicks received from the user 102.

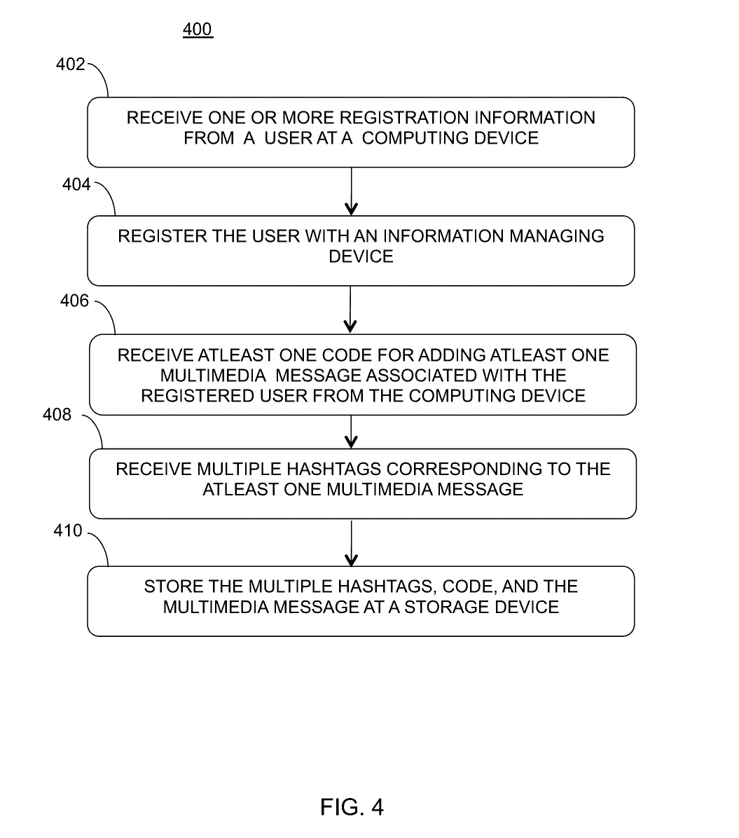

FIG. 4 is a flowchart illustrating an exemplary method 400 for registering a user and managing information including multimedia messages associated with the user, in accordance with an embodiment of the present disclosure. As discussed with reference to FIGS. 1A-1B, the user 102 (or first user 102) may enter atleast identifier at the computing device 104. The identifier may include a hashtag. The hashtag may be a word or phrase preceded by a hash sign (#) that is used social media websites, such as Facebook™, to identify messages or postings on a specific topic or theme. The computing device 104 may include the display device 108. The display device 108 may be configured to display one or more interfaces to the user 102. The user 102 may interact with the computing device 104 via the interfaces. The information managing device 110 may be configured to be part of the computing device 104 or may be located remotely from the computing device 104 in the network 114.

At step 402, one or more registration information may be received from a user, such as the user 102, at the computing device such as, the computing device 104. The user 102 may enter the registration information at a registration interface on the computing device 104. In some embodiments, the interface managing device 206 may display a registration interface at the display device 108 of the computing device 104. Then at step 404, the user 102 may be registered with the information managing device or system 110 based on the registration information provided by the user 102. In some embodiments, the registration device 204 may register the user 102 with the information managing device 110. The user 102 may choose a membership such as a primary membership and a secondary membership at the time of registration. An interface may be displayed to the user 102 based on his or her membership with the information managing device 110. In some embodiments, atleast five multimedia messages are displayed at the display device 108 in form of a ring or webring. The ring or webring may be a collection of websites or multimedia messages that are inked together in a circular structure, and may be arranged around a same theme. Further, the user 102 may be able to access the information managing device 110 based on his/her membership.

At step 406, atleast one code for adding atleast one multimedia message associated with the registered user 102 from the computing device 104 is received. The user 102 may enter the code for adding the multimedia message at the computing device 104. The transceiving device 202 may receive the code for adding the multimedia message from the computing device 104. At step 408, multiple hashtags corresponding to the multimedia message may be received. The user 102 may enter the multiple hashtags at the interface displayed at the computing device 104. The transceiving device 202 may receive the multiple hashtags from the computing device 104. Thereafter, at step 410, the multiple hashtags, code and the multimedia message are stored at the storage device 210. The code may be a software code written using suitable programming language such as C, C++, HTML, and so forth.

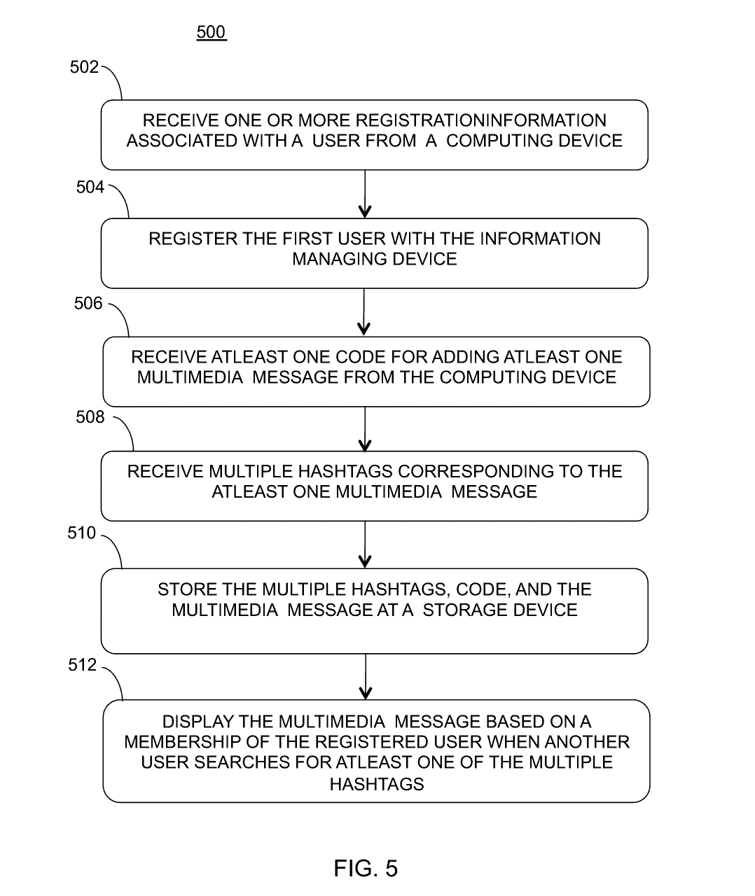

FIG. 5 is a flowchart illustrating an exemplary method 500 for registering a user, such as the user 102, and displaying information to the user, in accordance with an embodiment of the present disclosure. As discussed with reference to FIGS. 1A-1B an FIG. 2, the information managing device 110 can be accessed by the user 102 for managing hashtags and associated multiple multimedia messages or postings. The information managing device 110 may include multiple devices as already discussed in FIG. 2.

At step 502, one or more registration information associated with a user, such as the user 102, is received from a computing device such as, the computing device 104. The registration information may include information required for registering the user 102 with the information managing system or device 110. Examples of the registration information may include such as, but are not limited to, name, age, login identifier, password, date of birth, address, payment details, and so forth. The transceiving device 202 may receive the registration information from the computing device 104.

Then at step 504, the user 102 may be registered with the information managing device 110 based on the registration information. In some embodiments, the registration device 204 may register the first user 102 with the information managing device 110. The user 102 may choose a membership while registration. For example, the user 102 may choose a primary membership or a secondary membership. There may be a fee for membership of the information managing device 110. The user 102 can opt for or upgrade his/her membership in future also. Based on the membership, the user 102 may change the view of the interface at the display device 108. For example, the user 102 may insert the header and footer information in the multimedia message. Also, the user 102 having primary membership may be allowed to view multimedia messages in the header or in the footer on the interface.

At step 506, atleast one code for adding atleast one multimedia message is received from the computing device 104. In some embodiments, the transceiving device 202 receives the code from the computing device 104. Further, at the computing device 104, the user 102 may enter the code for adding the multimedia message.

At step 508, multiple hashtags (or identifiers) corresponding to the multimedia message are received from the computing device 104. The user 102 may enter the multiple hashtags at the computing device 104. In some embodiments, the transceiving device may receive the multiple hashtags from the computing device 104.

Then at step 510, the multiple hashtags, code, and the multimedia message are stored in the storage device 210 of the information managing device 110. In some embodiments, the hashtags, code, and the multimedia messages may be stored at any other device, such as a server device, in the network 114.

Thereafter, at step 512, the multimedia message may be displayed at an interface on the computing device 104 based on the membership of the registered user 102 when the user 102 or another user searches for atleast one of the multiple hashtags stored corresponding to the multimedia message. For example, if the another user enters a hashtag “#Wifi” then multimedia messages having “#Wifi” as hashtag are displayed. In some embodiments, atleast five multimedia messages are displayed at the display device 108 in form of a ring or webring. The ring or webring may be a collection of websites or multimedia messages that are inked together in a circular structure, and may be arranged around a same theme.

Further, the placement of multimedia messages on the interface on the display device may also depend on paid services subscribed by the user 102. For example, if the user 102 has paid a priority fee for displaying an associated multimedia message at a first position then whenever any user searches for a hashtag associated with a multimedia message associated with this hashtag then the multimedia message is displayed at a first or at initial position in the predefined order on the interface. The order of multimedia messages may be defined or determined by the interface managing device 206 based on the fees paid by the users associated with the multimedia messages. For example, the user 102 may avail paid services for displaying his/her associated multimedia message or advertisement at first position in the predefined order. Also, the user 102 may choose to display their multimedia message at first position in the predefined order whenever a particular hashtag is searched. The user 102 can also provide a list of hashtags on which the priority services need to be availed or his/her multimedia messages should appear first in the predefined order on the interface. In some embodiments, the user 102 may avail paid services for displaying their associated multimedia message at first position or initial positions in the predefined order whenever a location based identifier or hashtag is searched. Further, the user 102 may choose to get their multimedia messages displayed at first positions in the predefined order always whenever a hashtag associated with their multimedia message is searched at a particular time.

The interface managing device 206 may be configured to add a new multimedia message to the interface when a message addition fee is received from the first user 102 (or other user). The new multimedia message may be added based on an addition approval from the administrator 112. The interface managing device 206 may also be configured to remove a multimedia messages from the interface when a message removal fee and/or request is received from the first user 102 (or any other user). The multimedia message may be removed based on a message removal approval from the administrator 112.

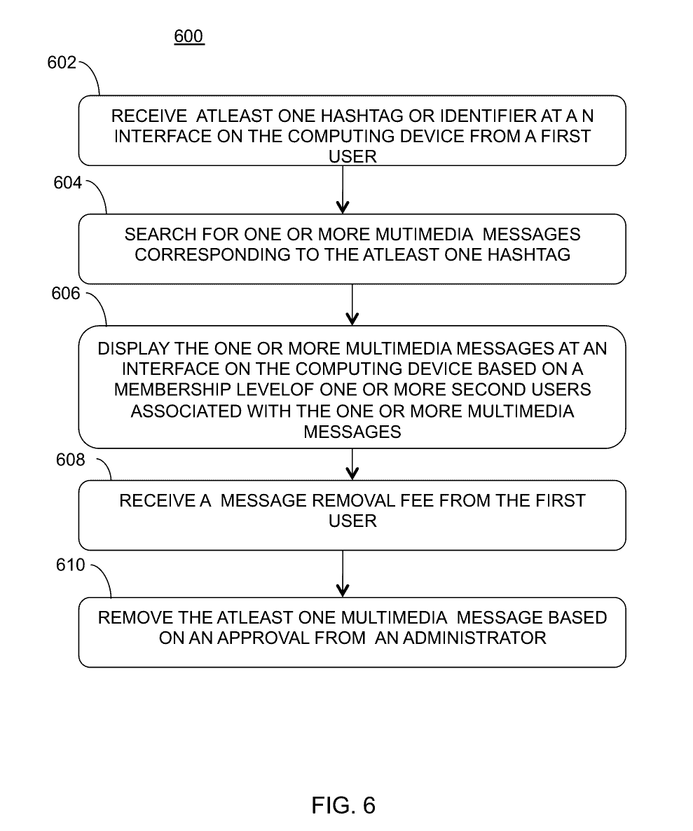

FIG. 6 is a flowchart illustrating an exemplary method 600 for removing atleast one multimedia message from an interface of the computing device 104, in accordance with an embodiment of the present disclosure. At step 602, atleast one hashtag (or identifier) is received at an interface displayed on the computing device 104 from the user 102. The user 102 may enter the hashtag by using an input device, such as a keyboard, on the computing device 104.

Then at step 604, one or more multimedia messages are searched for corresponding to the atleast one hashtag. In some embodiments, the information searching device 208 of the information managing device 110 searches for the one or more multimedia messages in the storage device 210. In alternative embodiments, the information searching device 208 of the information managing device 110 searches for the one or more multimedia messages in the social media websites over the network 114. The multimedia messages may be postings on the social media websites that may be created or done by a number of second users.

At step 606, the one or more multimedia messages are displayed at an interface on the display device 108 of the computing device 104 based on membership of the second users associated with the one or more multimedia messages. In some embodiments, the multimedia messages include advertisements associated with the second users or other users. In some embodiments, atleast five multimedia messages are displayed at the display device 108 in form of a ring or webring. The ring or webring may be a collection of websites or multimedia messages that are inked together in a circular structure, and may be arranged around a same theme. In some embodiments, placement of multimedia messages on the interface on the display device may also depend on paid services taken or subscribed by the user 102. For example, if the user 102 has paid a priority fee for displaying an associated multimedia message first then whenever any user searches for a hashtag associated with multimedia message associated with this hashtag then the multimedia message is displayed at a first or at initial position in the predefined order on the interface. The order of multimedia messages may be defined or determined by the interface managing device 206 based on the fees paid by the users associated with the multimedia messages. For example, the user 102 or a second user may avail paid services of the interface managing device 206 for displaying their associated multimedia message or advertisement at first place in the predefined order. Also, the user 102 may choose to display their multimedia message at first position in the predefined order whenever a particular hashtag is searched. The user can provide a list of hashtags on which the priority services need to be availed or his/her multimedia messages should appear first in the predefined order on the interface. In some embodiments, the user 102 may avail paid services for displaying their associated multimedia message at first position or initial positions in the predefined order whenever a location based identifier or hashtag is searched. Further, the user 102 may choose to get their multimedia messages displayed at first positions in the predefined order always whenever a hashtag associated with their multimedia message is searched.

Further at step 608, a message removal fee for removing atleast one message of the displayed one or more multimedia messages may be received from the first user 102. The user 102 may select the atleast one message from the displayed multimedia messages for removal. Thereafter, at step 610, the atleast one message is removed from the interface based on an approval from the administrator 112 of the information managing device 110. Till the time approval is not received from the administrator 112, the atleast one message will show on the display device and will be displayed in future searches too.

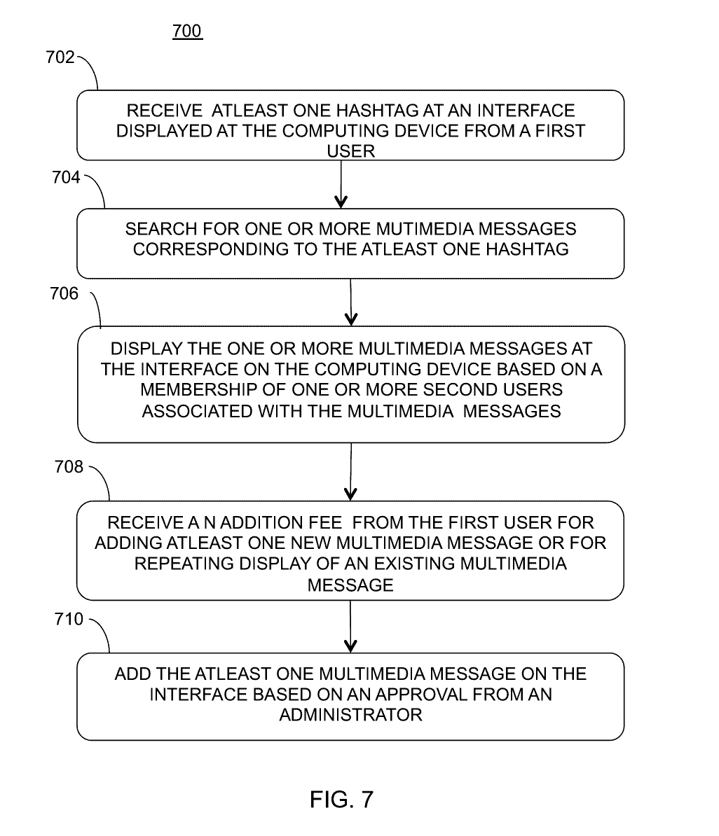

FIG. 7 is a flowchart illustrating an exemplary method 700 for adding atleast one new multimedia message at an interface on the computing device 104, in accordance with an embodiment of the present disclosure. At step 702, atleast one hashtag (or identifier) is received at an interface displayed at the computing device 104 from the user 102. The user 102 may enter the hashtag by using an input device, such as a keyboard, associated with the computing device 104.

Then at step 704, one or more multimedia messages are searched for corresponding to the atleast one hashtag. In some embodiments, the information searching device 208 of the information managing device 110 searches for the one or more multimedia messages in the storage device 210. In alternative embodiments, the information searching device 208 of the information managing device 110 searches for the one or more multimedia messages in various social media websites over the network 114. The multimedia messages may be postings on the social media websites that may be created or done by a number of second users.

The interface managing device 206 may be configured to add a new multimedia message to the interface when a message addition fee is received from the first user 102 (or other user). The new multimedia message may be added based on an addition approval from the administrator 112. The interface managing device 206 may also be configured to remove a multimedia messages from the interface when a message removal fee and/or request is received from the first user 102 (or any other user). The multimedia message may be removed based on a message removal approval from the administrator 112.

At step 706, the one or more multimedia messages are displayed at an interface on the display device 108 of the computing device 104 based on membership of the second users associated with the one or more multimedia messages. In some embodiments, the multimedia messages include advertisements associated with the second users. In some embodiments, atleast five multimedia messages are displayed at the display device 108 in form of a ring or webring. The ring or webring may be a collection of websites or multimedia messages that are inked together in a circular structure, and may be arranged around a same theme. Further, the multimedia messages may include hyperlinks. Therefore, when the user 102 selects a multimedia message from the displayed multimedia messages then a source webpage opens up. The source webpage may be a webpage from where the multimedia message is retrieved.

The user 102 may choose to display a multimedia messages on the interface more than once by paying a message addition fee. Further, the user 102 may choose to add a new message to the interface by paying an additional fees and providing details such as code associated with the multimedia message. Further at step 708, a message addition fee for adding atleast one message of the displayed one or more multimedia messages more than once is received from the first user 102. The message addition fee may be for adding a new multimedia message or for displaying a message more than once on the interface. The user 102 may select the atleast one message from the displayed multimedia messages for requesting the administrator to display it more than once on the interface. Thereafter, at step 710, the atleast one message is added based on an approval from the administrator 112 of the information managing device 110. Till the time approval is not received from the administrator 112, the atleast one message will be shown more than once on the interface. Post approval multiple instances of the atleast one message will be visible to the user 102 or other users in future searches.

In some embodiments, placement of multimedia messages on the interface on the display device 108 may depend on paid services taken or subscribed by the user 102. For example, if the user 102 has paid a priority fee for displaying an associated multimedia message first then whenever any user searches for a hashtag associated with multimedia message associated with this hashtag then the multimedia message is displayed at a first or at initial position in the predefined order on the interface. The order of multimedia messages may be defined or determined by the interface managing device 206 based on the fees paid by the users associated with the multimedia messages. For example, the user 102 may avail paid services for displaying their associated multimedia message or advertisement first in the predefined order on the interface for a time period. Also, the user 102 may choose to display their multimedia message at first position in the predefined order whenever a particular hashtag is searched. The user can provide a list of hashtags on which the priority services need to be availed or his/her multimedia messages should appear first in the predefined order on the interface. In some embodiments, the user may avail paid services for displaying their associated multimedia message at first position or initial positions in the predefined order whenever a location based identifier or hashtag is searched. Further, the user 102 may choose to get their multimedia messages displayed at first positions in the predefined order always whenever a hashtag associated with their multimedia message is searched at a particular time for example during 11 AM-9 PM time.

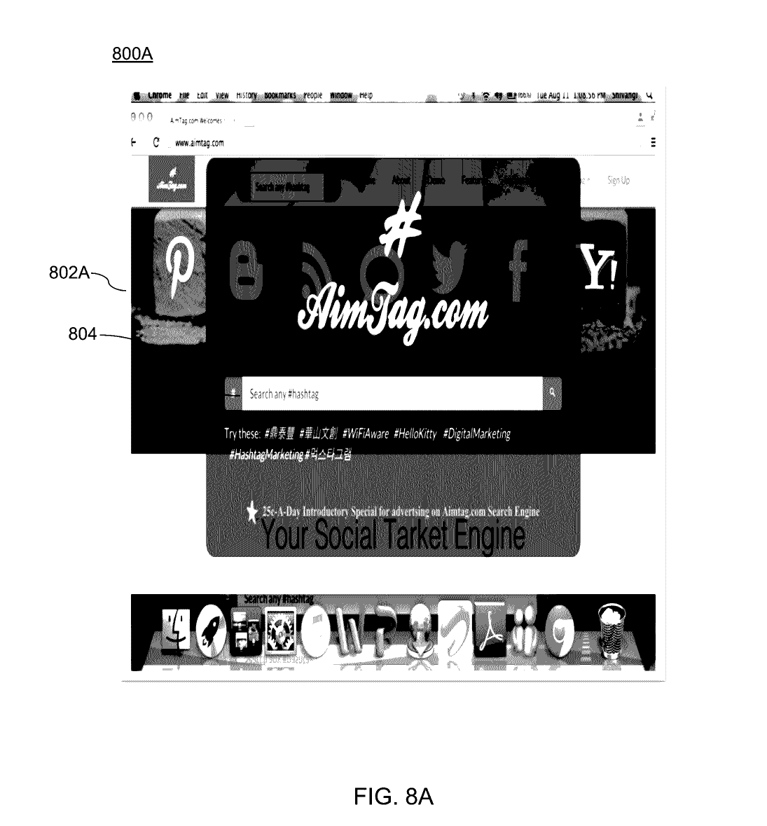

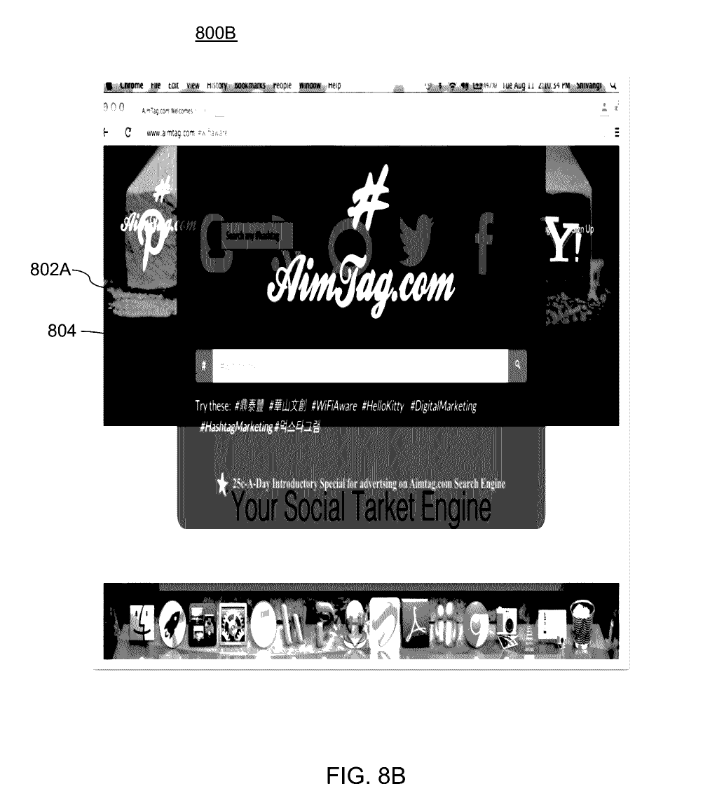

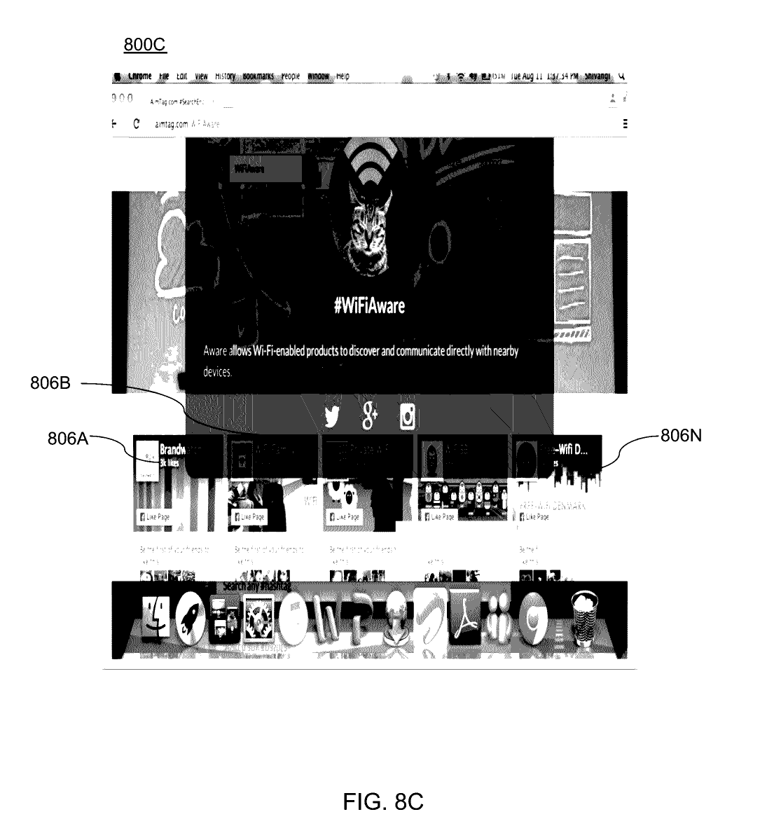

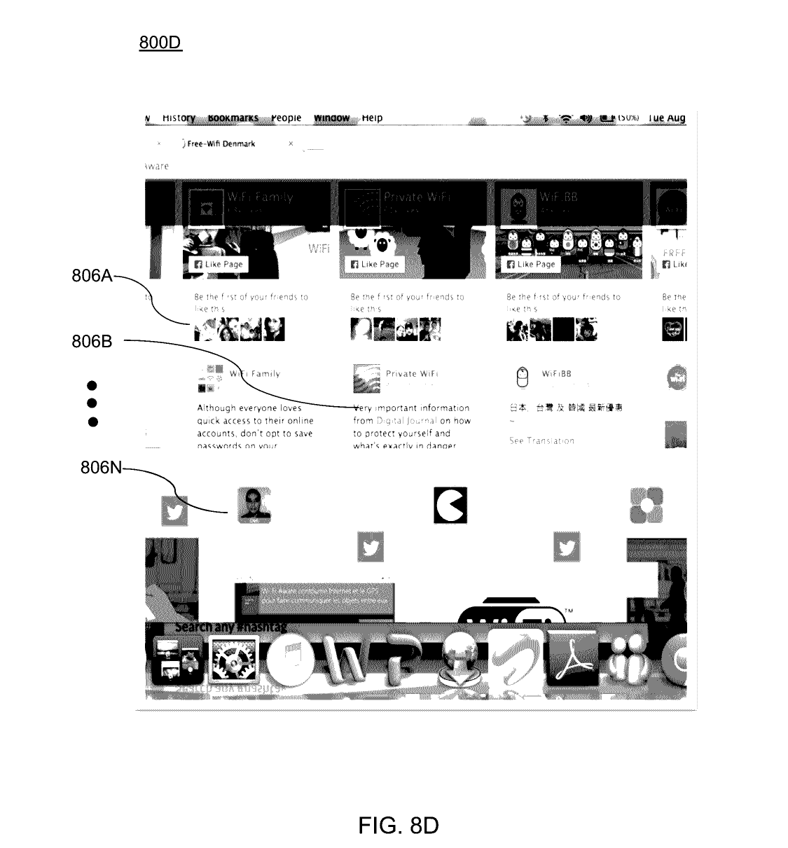

FIGS. 8A-8D depicts screenshots 800A-800D of interfaces 802A-802D for managing and displaying information on a computing device, in accordance with different embodiments of the present disclosure. As discussed with FIGS. 1A-1B, and FIG. 2, the interface managing device 206 may display interfaces on the display device 108 of the computing device 104. The interface managing device 206 may also be configured to change or switch interfaces on the display device 108 based on one or more inputs from the user 102. As shown in FIG. 8A, an interface 802A (or hashtag managing interface) includes atleast one search field 804. The user 102 may enter an identifier or a hashtag in the search field as shown in FIG. 8B. For example, the user 102 may enter a hashtag “#WiFiAware” in the search field 804. Though not shown, but the interface 802A may include multiple search fields 804. Further, the user 102 may be allowed to enter more than one identifier or hashtag in the search field 804. As shown in an interface 802B, the user 102 can enter a hashtag in the search field 804. The hashtag as shown is prefixed by a hash symbol i.e. “#”. In some embodiments, other symbols such as, but not limited to, “@”, “!”, “&”, “$”, and so forth may be used. In alternative embodiments no symbol may be prefixed along with the identifier.

Turning to FIG. 8C, where an interface 802C is shown including multiple multimedia messages 806A-806N. Each of the multimedia messages may include a hyperlink or an embedded resource uniform resource locator (URL) address. Therefore, when the user 102 clicks or selects one of the multimedia message, the interface may change and a source website where the multimedia message is originally posted may open up. FIG. 8D is an interface showing multiple multimedia messages 806A-806N when screen is scrolled down. In some embodiments, the user may avail paid services for displaying their associated multimedia message at first position or initial positions in the predefined order whenever a location based identifier or hashtag is searched. Further, the user 102 may choose to get their multimedia messages displayed at first positions in the predefined order always whenever a hashtag associated with their multimedia message is searched at a particular time for example during 11 AM-9 PM time.

A computer program product including program instructions tangibly stored on a computer-readable medium and operable to cause a computer system to perform the method disclosed herein may be an application software that enables a computing device to capture unique strings included within identifiers being broadcasted by a wireless access device. The unique identifier may be an SSID. The application program may further provide an interface that permits the user to choose and attach specific unique strings to the content being posted on social media. In an alternate embodiment the application software may be configured to automatically post content on pre designated social media platforms along with the chosen unique strings attached to such content.

It will be understood that the devices and the databases referred to in the previous sections are not necessarily utilized together method or system of the embodiments. Rather, these devices are merely exemplary of the various devices that may be implemented within a computing device or the server device, and can be implemented in exemplary another devices, and other devices as appropriate, that can communicate via a network to the exemplary server device.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A method for online management of information in a network, the method comprising:
displaying, by an interface managing device, an interface at a display device of a computing device, wherein the interface comprising atleast one search field for enabling a first user to enter atleast one identifier in the atleast one search field;
receiving, by a transceiving device, the atleast one identifier from the computing device, wherein the atleast one identifier comprises atleast one hashtag;
searching, by an information searching device, for one or more multimedia messages corresponding to the atleast one identifier; and
displaying, by the interface managing device, the one or more multimedia messages at the interface on the display device in a predefined order based on a membership of a plurality of second users associated with the one or more multimedia messages.

2. The method of claim 1, wherein the each of the one or more multimedia messages comprises a hyperlink for allowing the first user to browse to a source website associated with each of the one or more multimedia messages.

3. The method of claim 2, wherein atleast five multimedia messages are displayed at the display device in form of a ring based on a membership and paid services availed by the plurality of second users.

4. The method of claim 3 further comprising:
removing, by the interface managing device, atleast one of the one or more multimedia messages from the interface displayed on the computing device when a message removal fee is received from the first user, wherein the atleast one multimedia message is removed based on a removal approval from an administrator; and
adding, by the interface managing device, a new multimedia message to the interface displayed on the computing device when a message addition fee is received from the first user, wherein the new multimedia message is added based on an addition approval from the administrator.

5. The method of claim 4 further comprising searching, by the information searching device, for the one or more multimedia messages corresponding to the atleast one hashtag in a plurality of social media websites, wherein the one or more multimedia messages comprises a plurality of postings including the atleast one of the atleast one identifier, an advertisement, a software plugin, and a widget.

6. The method of claim 5 further comprising registering, by a registration device, the plurality of second users based on registration information provided by the plurality of second users.

7. The method of claim 6 further comprising displaying, by the interface managing device, the interface to the registered plurality of second users based on a membership of each of the plurality of second users and paid services subscribed by the plurality of second users, wherein the membership comprises a primary membership, and a secondary membership.

8. An information managing system for online management of information in a network, the system comprising:
an interface managing device configured to display an interface including atleast one search field at a display device of a computing device, wherein a first user enters atleast one identifier in the atleast one search field;
a transceiving device configured to receive atleast one identifier from the computing device, wherein the atleast one identifier comprises atleast one hashtag;
an information searching device configured to search for one or more multimedia messages corresponding to the atleast one identifier; and
a storage device configured to store the one or more multimedia messages, information about the first user and a plurality of second users, and a plurality of identifiers including hashtags;
wherein the interface managing device is further configured to display the one or more multimedia messages at the interface on the computing device in a predefined order based on a membership of and paid services availed by the plurality of second users associated with the one or more multimedia messages.

9. The information managing system of claim 8, wherein the each of the one or more multimedia messages comprises a hyperlink for allowing the first user to browse to a source website associated with each of the one or more multimedia messages, further wherein atleast five multimedia messages are displayed at the display device in form of a ring based on the membership of and paid services availed by the plurality of second users and the first user.

10. The information managing system of claim 9, wherein the interface managing device is further configured to:
remove atleast one of the one or more multimedia messages from the interface of the computing device when a message removal fee is received from the first user, wherein the atleast one multimedia message is removed based on a removal approval from an administrator; and
add a new multimedia message to the interface when a message addition fee is received from the first user, wherein the new multimedia message is added based on an addition approval from the administrator.

11. The information managing system of claim 10, wherein the information searching device is further configured to search for the one or more multimedia messages corresponding to the atleast one hashtag in a plurality of social media websites in the network, further wherein the one or more multimedia messages comprises a plurality of postings including atleast one of the atleast one identifier, an advertisement, a software plugin, and a widget.

12. The information managing system of claim 11 further comprising a registration device configured to register the plurality of second users based on registration information provided by the plurality of second users.

13. The information managing system of claim 12, wherein the interface managing device is further configured to display the interface to the registered plurality of second users based on a membership of each of the plurality of second users, wherein the membership comprises a primary membership, and a secondary membership.

14. A method for enabling a plurality of users to manage a plurality of hashtags in a network, the method comprising:
registering, by a registration device, a user of the plurality of users based on one or more registration information provided by the user on an interface at the computing device;
displaying, by an interface managing device, a hashtag managing interface including atleast one search field at a display device of the computing device;
receiving, by a transceiving device, atleast one hashtag from the computing device, wherein the atleast one hashtag is entered by the user in the atleast one search field at the computing device;
searching, by an information searching device, for one or more multimedia messages corresponding to the received atleast one hashtag in a storage device, wherein the storage device stores the plurality of hashtags, the one or more multimedia messages, and membership information of the plurality of users; and
displaying, by the interface managing device, the one or more multimedia messages at the interface on display device of the computing device in a predefined order based on a membership and paid services availed by the user, wherein the membership comprises a primary membership, and a secondary membership.

15. The method of claim 14, wherein the each of the plurality of the multimedia message comprises a hyperlink, further wherein the user can browse to a source website associated with the one or more multimedia messages, further wherein atleast five multimedia messages are displayed at the interface in form of a ring based on the membership of the plurality of users.

16. The method of claim 15 further comprising:
removing, by the interface managing device, atleast one of the one or more multimedia messages from the interface of the computing device when a message removal fee is received from the user, wherein the atleast one multimedia message is removed based on a removal approval from an administrator; and
adding, by the interface managing device, a new multimedia message to the interface when a message addition fee is received from the user, wherein the new multimedia message is added based on an addition approval from the administrator.

17. The method of claim 16 further comprising searching, by the information searching device, for the one or more multimedia messages corresponding to the atleast one hashtag in a plurality of social media websites, wherein the one or more multimedia messages comprises atleast one posting including atleast one of the atleast one identifier, an advertisement, a software plugin, and a widget.

18. A system for enabling a plurality of users to manage a plurality of hashtags in a network, comprising:
a registration device configured to register a user of the plurality of users based on one or more registration information provided by the user at the computing device;
a storage device configured to store a plurality of hashtags, membership information of the plurality of users, one or more multimedia messages, the one or more registration information, and one or more codes for linking the one or more multimedia messages;
an interface managing device configured to display a hashtag managing interface including atleast one search field at the computing device;
a transceiving device configured to receive atleast one hashtag from the computing device, wherein the atleast one hashtag is entered by the user in the atleast one search field at the computing device; and
an information searching device configured to search for one or more multimedia messages corresponding to the received atleast one hashtag in atleast one of the storage device and a plurality of social media websites, wherein the one or more multimedia messages comprises atleast one posting including atleast one of the atleast one identifier, an advertisement, a software plugin, and a widget;
wherein the interface managing device is further configured to display the one or more multimedia messages at the interface on the computing device based on a membership, and paid services availed by the plurality of users, wherein the membership comprises a primary membership, and a secondary membership.

19. The system of claim 18, wherein each of the one or more multimedia messages comprises a hyperlink for allowing the user to browse to a source website associated with each of the one or more multimedia messages, further wherein atleast five multimedia messages are displayed at the interface in form of a ring based on the membership and paid services availed by the plurality of the users.

20. The system of claim 19, wherein the interface managing device is further configured to:
remove atleast one of the one or more multimedia messages from the interface of the computing device when a message removal fee is received from the user, wherein the atleast one multimedia message is removed based on a removal approval from an administrator; and
add a new multimedia message to the interface when a message addition fee is received from the user, wherein the new multimedia message is added based on an addition approval from the administrator.
